(19) United States
(12) Patent Application Publication
(10) Pub. No.: US 2022/0150224 A1
(43) Pub. Date: May 12, 2022

(54) ENCRYPTION USING RECURSIVE KEY

(71) Applicant: Timothy John Courtney, Longmont, CO (US)

(72) Inventor: Timothy John Courtney, Longmont, CO (US)

(21) Appl. No.: 17/524,741

(22) Filed: Nov. 12, 2021

Related U.S. Application Data
(60) Provisional application No. 63/113,046, filed on Nov. 12, 2020.

(51) Int. Cl. H04L 9/40; H04L 9/08; H04L 9/06

(52) U.S. Cl. CPC H04L 63/0428; H04L 9/0618; H04L 9/0861

(57) ABSTRACT

A recursive hash infinite pad process for securing data is disclosed. The process shared secrets to recursively create a key which may be used to encrypt and decrypt data.

### CROSS-REFERENCE TO RELATED APPLICATIONS

This application claims the benefit of U.S. Provisional Application No. 63/113,046, filed Nov. 12, 2020, which is hereby incorporated by reference in its entirety.

### BACKGROUND

### Technical Field

The present invention pertains to methods for securing information and protecting electronic data, in motion and at rest, using encryption.

Today, protecting the security of information assets and electronic data is important in all aspects of commercial and personal life. Owners and users of electronic information employ various measures to protect their data depending on their security objectives. Processes have been developed to achieve the various aspects of security, including confidentiality and data integrity. Encryption and decryption methods are tools for enhancing confidentiality objectives. But encryption and decryption have related costs, namely, costs associated with software and hardware resources to implement the desired level of confidentiality or data integrity, as well as speed of processing and transmission which can translate into pecuniary liabilities. Therefore, the security of data and computation efficiency are both important considerations. Accordingly, solutions that improve security, speed, and resource efficiency in encryption and decryption are highly desirable.

One aspect of improving efficiency is to increase processing speed. Another aspect is to reduce hardware and software requirements. Reduction in hardware and software may also improve security by reducing points of vulnerability. Security may also be improved by decreasing the chance that a cipher may be broken and by making the encryption quantum resistant. Moreover, a robust and less complicated security system may reduce unintended consequences from system management complexities which may reduce security, decrease flow, and drive up cost. These and other benefits may be accomplished by using the present teachings.

### SUMMARY

The present disclosure provides an efficient, fast, easy, and cost effective method and system to secure information or data in motion or at rest. One aspect of the present invention includes encryption and decryption (collectively referred to as “encryption”), referred to as recursive hash infinite pad (“RHIP”).

The disclosure sets forth a process which may be employed with protocols that require keys or key streams to encrypt or to decrypt data. In one aspect, the key or key stream may be a one-time pad (OTP). The process may be used to encrypt quickly, require less resources, be more computationally efficient, and be more secure including being quantum resistant.

In one aspect, a method is taught for securely moving data from a first device to a second device co the steps of establishing a communication session between the first device and the second device; storing a first secret on the first device; storing the first secret on the second device; storing a second secret on the first device; storing the second secret on the second device; combining a first information derived from the first secret with second information derived from the second secret, using one of an exclusive or function or a hash function, on the first device to create a first iteration-one key; combining a third information derived from the first secret with fourth information derived from the second secret, using one of an exclusive or function or a hash function, on the second device to create a second iteration-one key; encrypting at least a portion of the data on the first device using the first iteration-one key to generate a first encrypted text; moving the first encrypted text from the first device to the second device; and decrypting the first encrypted text using the second iteration-one key on the second device.

The method may further include replacing the first secret with the first information on the first device; and replacing the second secret with the second information on the first device. It may further comprise replacing the first secret with the third information on the second device; and replacing the second secret with the fourth information on the second device. It may further comprise a step of modifying the first secret by adding the first information to the first secret to generate a modified first secret; and using the modified first secret to generate a first iteration-two key to encrypt at least a portion of the data on the first device; or the step of transmitting the encrypted at least a portion of the data to the second device; or the steps of modifying the first iteration-one key n successive times to create a first iteration-n key; or multiple steps of modifying the first secret by replacing it with a hash value derived in an iteration to generate a new key for encrypting at least a portion of the data.

The method may further comprise the first secret and the second secret being derived from an initial secret; or the initial secret being generated during a handshake between the first device and the second device; or the first and second information being derived by using one of a hash function or an exclusive or function; or the third and fourth information being derived by using one of a hash function or an exclusive or function; or a third secret being stored on the first device and on the second device, and wherein the third secret is used in generation of the first iteration-one key and the second iteration-one key.

In another aspect, a method is taught for protecting the confidentiality of data comprising the steps of selecting a key number; storing a first secret; storing a second secret; combining a. first information derived from the first secret with second information derived from the second secret using one of an exclusive or function or a hash function to create a first iteration key; combining the first iteration key with the first secret to create a second iteration key; continuing to combine each iteration key with the previous iteration key a number of iterations equal to the key number to obtain the final iteration key; encrypting at least a portion of the data using the final iteration key to generate a first encrypted text; and decrypting the first encrypted text using the final iteration key.

In another aspect a system is taught which comprises an electronic pathway from the first location to the second location; first memory associated with the first location wherein said first memory stores a first secret for use on the first location; second memory associated with the first location wherein said second memory stores a second secret for use on the first location; third memory associated with the second location wherein said third memory stores a first secret for use on the second location; fourth memory associated with the second location wherein said fourth memory stores a second secret for use on the second location; one of a first hash function or a first exclusive or function associated with the first location configured to generate a first key from processing one of the first secret or the second secret at the first location; one of a second hash function or a second exclusive or function associated with the second location configured to generate a second key from processing one of the first secret or the second secret at the second location; an encryption function associated with the first location configured to encrypt data at the first location with the first key; a decryption function associated with the second device configured to decrypt the encrypted data from the first device using the second key; wherein the first and second keys are equal in value.

The system may comprise at least one of the first hash function, the second hash function, the first exclusive or function, the second exclusive or function implemented in hardware in electrical communication with at least one of the first location or the second location. It may comprise at least one of the first hash function, the second hash function, the first exclusive or function, the second exclusive or function implemented in software.

In another aspect a system is taught for encrypting data comprising a processor configured to execute a hash function and an exclusive or function; memory configured to store a first secret and a second secret; memory configured store a hash of the first secret as a first hash and a hash of the second secret as a second hash; a processor configured to combine the first and second hashes using an exclusive or function to obtain a first-iteration key; an encryption module configured to encrypt at least a first portion of the data using the first iteration key to obtain a first ciphertext; communication module configured to transmit said first ciphertext; a processor configured to replace the first secret with the first hash to obtain a third hash and to replace the second secret with the second hash to obtain a fourth hash; a processor configured to combine the third and fourth hashes using an exclusive or function to obtain a second-iteration key; the encryption module additionally configured to encrypt at least a second portion of the data using the second iteration key as the cipher to obtain a second ciphertext; and the communication module additionally configured to transmit said second ciphertext.

The system may comprise the processor being configured to concatenate a subsequent hash from the first secret with a previous hash from the first secret and combine the result with the concatenation of a subsequent hash from the second secret with a previous hash from the second secret, a desired number of times.

### BRIEF DESCRIPTION OF THE DRAWINGS

FIG. 1 depicts a process flow according to an embodiment of the invention.

FIG. 2 depicts one embodiment of the process of generating a one-time pad.

FIG. 3 depicts one embodiment of a process of encrypting a data block.

FIG. 4 depicts one embodiment of a process of decrypting a data block.

FIG. 5 depicts a flow of multiple iterations to generate the OTP and encrypt data using a recursive hash algorithm and two secrets.

FIG. 6 depicts the decryption flow for the embodiment of FIG. 5.

FIG. 7 depicts an embodiment showing encryption using dual secrets and a double has

FIG. 8 depicts the corresponding decryption process for the process of FIG. 7.

FIG. 9 depicts an embodiment showing encryption using dual secrets and one hash function.

FIG. 10 depicts the corresponding decryption process for the process of FIG. 9.

FIG. 11 depicts an embodiment showing encryption using two secrets and one hash function.

FIG. 12 depicts the corresponding decryption process for the process of FIG. 11.

### DETAILED DESCRIPTION

In the following detailed description, numerous specific details are set forth by way of examples in order to provide a thorough understanding of the relevant teachings of this disclosure. It should be noted, however, that the present teachings may be practiced without such details. In other instances, methods, procedures, and components have been described at a relatively high level. In those instances, the disclosure provides sufficient detail to describe and enable it to a person of ordinary skill, but avoids providing so much detail as to obscure aspects of the invention.

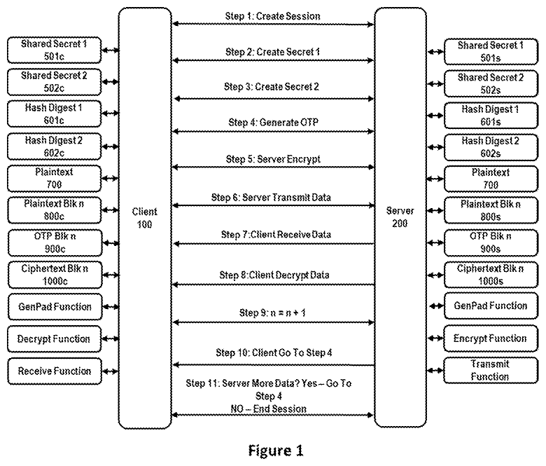

FIG. 1 shows a process flow according to one embodiment. In the embodiment of FIG. 1, a first user transmits data to a second user. The users may be any type of user without limitation, including individual persons who transmit or receive private data. The users may also be any entity which transmits large amounts of data and their customers, clients, or subscribers. For example, the first user may be a company who provides streaming services, for example media content and movies, to its subscribers or customers. By using the present teachings, that first user could implement a quantum resistant streaming service and its customer devices would require less hardware and be cheaper to implement and deploy.

By way of one, non-limiting example, the first user may be a video streaming platform and its associated servers, and the second user may be the smartphone of a client who subscribes to the streaming service and accesses the service on her smartphone (corresponding to client 100 in FIG. 1). The session in Step 1, FIG. 1, may start with the client logging into her streaming service to watch a movie or a sporting event.

The user may also be an entity that enables secure communication between multiple devices in either a peer-to-peer relationship or a client-service configuration. Users may include owners of any devices which transmit or receive data or any entity who uses or operates a device which transmits or receives data.

Other users may include those who collect field data such as for scientific purposes or use technical instrumentation and transmit information to and from the field, their instruments, a central facility, headquarters, or other peer devices. The present teachings provide for protection of data while in motion at any stage.

Other types of users may include entities who provide processing or storage services. The present teachings can be used to secure the data while in storage or at rest. In general, any user who wishes to secure its data while at rest using encryption will benefit from the present teachings. For users who store individual files or data containers for a number of customers on a same device, each data container would be protected by the owner's password that would be used to generate a key that would be used to encrypt/decrypt the shared secrets that are securely stored as part of the data container.

Additionally, a user need not be a person or an entity but rather their hardware or software. That is, the users may be devices or processing modules. The first user may be the transmitting device and the second user may be the receiving device. In fact, two parts of a single device may act as the first and second users by using the present teachings to communicate with each other over an internal data bus. For example, one micro-processor in a computer can establish a dedicated connection with another micro-processors in that computer and utilize the present teachings. For example, microprocessor, or other internal device, can establish a connection, to read and write data to and from an internal cache memory using the present teachings. Alternatively, a processing unit can use the present teachings to reading and write data to permanent storage. The term user, or the terms client and server, refer to parties in the transaction and not to a particular device or entity type, and may be persons, entities, devices, or modules or units within a computing device.

The server or the client may each comprise dedicated computing devices, servers, distributed systems, or cloud-based computing mechanisms which provide the requisite functions. The server and client may be peer devices, dedicated devices, or connections which are not in a server-client relationship.

Accordingly, any user may use this process to achieve the benefits of fast, efficient, and secure data protection. Moreover, these benefits are applicable to data at rest, data in motion, streaming or non-streaming, stored information, password protected or otherwise secured, and to device-device communications or within device communications, whether wired or wireless, whether over the internet, in an internal network, or over an internal bus, and whether dedicated, peer-to-peer, or in a client-server relationship.

In FIG. 1, the first user is referred to as server 200 and the second user is referred to as client 100. In Step 1, a session is created to establish electronic communication between the server 200 and the client 100. Client 100 may establish the session with any known or acceptable protocol. This session may be secure or insecure. Alternatively, the server may initiate the session.

If the connection is insecure, the parties can initiate a handshake or a key exchange to generate two or more shared secrets (Step 2 and Step 3). For example, an insecure session may use a Diffie-Hellman algorithm to generate two secrets. Alternatively, it can be used to generate one secret which is split into two portions to be used as the two secrets in Step 2 and Step 3. If the session is already secure, the server may generate the two secret keys that will be used as the secrets in Step 2 and Step 3 and send them to the client in a secure manner. The secure connection can be established in any manner including TLS, HTTPS, SSH or other known methods.

By way of one specific example, the client may initiate a connection using a transport layer security (“DTLS” or “TLS”) protocol with a server. The client may complete the handshake, establish a session, and then employ the present teachings to secure data and transmit or store it. Alternatively, after initiating the TLS handshake, the client may choose the present teachings of RHIP as the encryption preference for its secure session. To this end, the present teachings can be used with all security protocols that are symmetric or asymmetric in establishing a secure session. Some current encryption methods include RSA. Diffie-Hellman, EOM, EDH, and EECDH. The present teachings can be practiced in conjunction with any of these methods or future or more secure methods currently not in practice.

For example, a Diffie Hellman key exchange may be used to establish one or more secrets between a client and a server which have no prior knowledge of each other. Alternatively, the secret or a set of secrets may be pre-shared between the parties and then the secret or one of the secrets may be selected in another manner. The present teachings are applicable to any of these methods.

Alternatively, a key generated according to the present teachings may be broken down into a set of keys for an Advanced Encryption Standard (AES) protocol. Each AES encryption key may be equal to the OTP block generated by each step in the recursive process of the present teachings. If the OTP block is larger than an AES key, then only a subset of the OTP need be used. For example, if the size of the AES key in a particular process is 128 bits, the first 128 bits of the OTP may be used as the AES key. Alternatively, any given subset may be used.

Once the session is established in Step 1, two secrets 501 and 502 are created. In Step 2, the first secret 501 is generated and saved on the client as 501c and on the server as 501s. Note that 501c and 501s are the same value. In Step 3, a second secret 502 is created. The value corresponding to secret 502 is stored at the client 100 as 502c and at the server 200 as 502s. 502c and 502s are equal in value.

As already stated, the Diffie-Hellman key exchange or any other approved key exchange algorithm may be used to create the first and second secrets. Additionally, there is no temporal requirement for the creation of the secrets as they can be pre-shared by some other scheme. Moreover, more than two secrets can be created. That is, a desired number, i, of secrets can be created. In such a case, the step of creating a shared secret between the client and the server will occur i times, In the embodiment of FIG. 1, i=2 and therefore two steps, Step 2 and Step 3, depict the creation of the shared secrets.

By way of one non-limiting example, the client and the server may publicly may agree to two parameters p=23 and g=3 to establish their first secret. The client chooses a secret integer a=5. The client them calculates the value A, where A=g^{a} mod(p) (which is equal to 13 as calculated by 3⁵ mod(23)). The client transmits A to the server. The server chooses a secret integer b=2. The server calculates B=9 and transmits it to the client, where B=g^{b} mod(p)=3²mod(23)=9. The client generates the first secret by calculating B^{a} mod(p)=9⁵ mod(23)=8 and stores it as 501c. The server generates the first secret by calculating A^{b} mod(p)=4³ mod(23)=8 and stores it as 501s. In this way, both the client and server have created a shared secret equal to the value 8 which is saved as 501s sever side and 501c client side.

To generate the second secret, the client and the server publicly agree to use p=17 and g=3. The client chooses a=11 and transmits the value A to the server, where A=g^{a} mod(p)=3¹¹ mod(17)=7. The server chooses a secret integer b=6 and sends B=mod(p)=3⁶ mod(17)=15 to the client. The client generates the second secret equal to B^{a} mod(p)=15¹¹ mod(17)=9. The server generates the second secret equal to A^{b} mod(p)=7⁶ mod(23)=9. Each of the server and the client save this second secret as 502s and 502c respectively, In practice, the size of secrets would generally be much larger to ensure sufficient security. For examples, the secret may be a 2048 bit value.

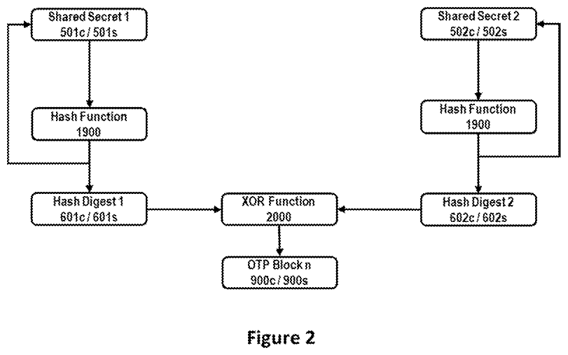

In Step 4, an OTP may be created from the secrets using the process reflected in FIG. 2. As shown in FIG. 2, stored secret 501c is run through a hash algorithm 1900 on the client side to obtain hash digest 601c. The hash digest 601c is stored client side by overwriting the first secret 501c. Alternatively, both the first secret 501c and the hash digest 601c may be stored temporarily or permanently for implementations where future access to these values is required. In the implementation of FIG. 2, the GenPad Function replaces the first secret 501c with the hash digest 601c, Additionally, stored secret 501s is run through a hash algorithm on the server side to obtain hash digest 601s. The hash digest 601s is stored server side as explained above with respect to hash digest 601c. The second secret 502 is also run through the hash algorithm on the client side to obtain 602c and on the server side to obtain 602s. The resulting hashed values (also referred to as hash digests) 602c and 602s are stored at the client and server respectively, similar to that described for the first secret. Once the client and server hash digests are obtained for the first secret, 601c and 601s, and for the second secret, 602c and 602s, they are used to create an OTP.

As shown in FIG. 2, the bitwise exclusive or (XOR) of the hash digests 601s and 602s on the server side is calculated using the XOR function 2000. The resulting calculated value is 900s which is returned by the function GenPad. That value 900s is stored and on the server side and used as the OTP server side (Step 4). The same process occurs on the client side and the value 900c is returned and stored. Once the OTP is generated, the data can be encrypted, transmitted, and decrypted. To encrypt the data, especially when large amounts of data is transmitted, the data is divided into data blocks for encryption and transmission. Therefore, plaintext 700 may be divided into data blocks 800s, 800s-1, and so on, as is known in the art.

In the embodiment of FIG. 1, in Step 5, the first data block is be encrypted using the OTP generated for that data block. The encrypted data block is referred to as ciphertext 1000s on the server side. In Step 6, the ciphertext 1000s is transmitted to the client 100. In Step 7, the client receives the ciphertext and stores it as 1000c. In Step 8, ciphertext 1000c may be decrypted, client side, and saved as block 800c. The value 800c is equal to that of 800s. As such, the first block of the data from plaintext 700, corresponding to the n=0 iteration, is securely transmitted from the server to the client. As the data blocks are received on the client side, they are used to reconstruct the plaintext 700.

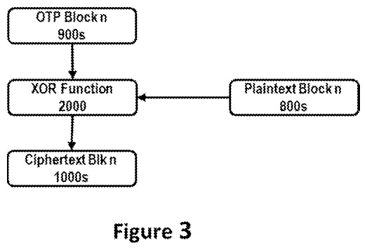

FIG. 3 is a flow of the process for encrypting data block 800s in Step 5 of FIG. 1. OTP 900s and plaintext block 800c are processed through XOR function 2000 to generate the ciphertext 1000s. In Steps 6-7 of FIG. 1, the ciphertext 1000s is transmitted from the server to the client and stored as 1000c client-side.

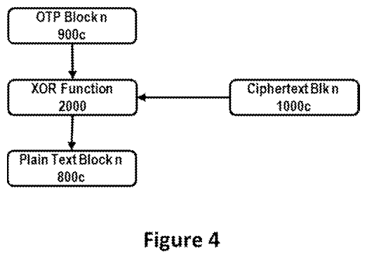

In Step 8, the received ciphertext is decrypted. FIG. 4 is a flow of the process for decrypting the cipher text 1000c. OTP 900c and ciphertext 1000c are processed through XOR function 2000 to generate the unencrypted data block 800c equal to the first data block 800s of the plaintext 700.

If the entirety of the data was processed in this iteration, the process ends. If there is more data to transmit, the process proceeds to the next iteration, n+1 in Step 9 of FIG. 1, In Step 10, the process repeats Step 4 to Step 11 for each remaining data block, each time incrementing its iteration to n+1, n+2, and so on.

It plaintext 700 included a second data block 800s-1, that data block would correspond to the n=1 or the second iteration. The OTP for this next iteration is returned in Step 4 and stored as 900s-1 for the n=1 iteration. The second data block is encrypted by a 900s-1, transmitted, decrypted, and so on. Each iteration of the OTP may overwrite the past value. Alternatively, some of the OTPs may be stored, temporarily or permanently, for particular applications as discussed below.

As seen in FIG. 2, to obtain the OTP for the second iteration, the shared secret 1, which has a value of 601s after the first iteration n=0, is run through the hash function 1900 which applies a hash algorithm to obtain the hash value 601s-1. On the client side, 601c is run through the hash function 1900 to generate 601c-1. Similarly, with respect to the second secret, 602c is hashed to obtain 602c-1. On the server side, a similar process yields 602s-1. The resulting hash values 601s-1 and 602s-1 are stored on the server side. Corresponding values, 601c-1 and 602c-1 are stored on the client side.

Each iteration of these hash values may overwrite the previous one but may also be preserved, temporarily or permanently. For example, in the second iteration n=1, the value 601c may be concatenated with the original secret 1, 502c, and the resulting value hashed to yield 601c-1. Therefore, preservation of 502c for retrieval and processing in the GenPad function would be desirable and is contemplated for this type of implementation. The same is true for all future iterations of either the first or the second secrets and their hash digests,

Once the hashed concatenated values for the first and secrets, 601s-1 and 602s-1, are generated, they are input to an XOR function 2000 which calculates their bitwise exclusive or (XOR) value. That value is returned and stored server side as 900s-1 and is used as the OTP for encryption on data block n=1. The same process occurs on the client side where 601c-1 and 602c-1 are combined in the XOR function to return 900c-1. This value is used as the OTP for decryption of data block n=1 at the client. Each iteration of the OTP may replace the previous one by overwriting it. Alternatively, all or some of the iterations of the OTP may be stored, temporarily or permanently, where required for the particular implementation.

On the server side, OTP 900s-1 is used to encrypt the data block 800s-1 associated with the n=1 iteration. For example, 800s-1 and 900s-1 may be input into an XOR function to encrypt 800s-1. The resulting encrypted value is ciphert xt 1000s-1 which is stored on the server. It is transmitted to the client and saved as cipher text 1000c-1 at the client. It is then decrypted using the OTP 900c-1 client side to obtain data block 800c-1. This data block may be joined with 800c from the n=0 iteration to reconstruct plaintext 700. In this manner, each iteration of the process creates an OTP on each of the client and server sides to be used to encrypt and decrypt data blocks.

For example, the hundredth data block is encrypted using OTP 900s-99 on the server side that is, it is encrypted using the OTP generated at the 100th iteration according to the process shown in FIG. 2 (n=99). The data blocks may be transmitted to a client which then decrypts them and constructs the original plaintext.

If multiple data blocks are transmitted, each block may be received, decrypted and the plaintext used in order, for example in a streaming application. Alternatively, an encrypted data block may be decrypted and stored for future reconstruction. That is, multiple data blocks may be used to reconstruct the plaintext only after all the data blocks are received or confirmed. Additionally, some applications may not require a particular order in receiving, decrypting, or reconstructing the plaintext. Where the order of encryption and decryption is not observed, it may be required to preserve the iterations of the OTP instead of overwriting them.

The present teachings may be used with connectionless streaming protocols, such as the User Datagram Transport Layer Security (DTLS) which is based on the User Datagram Protocol (UDP). In these protocols, usually only the most current OTP is of interest because data packets are sent only one time and delivery is not guaranteed or acknowledged. Therefore, all previous OTPs can be overwritten by the current one.

The present teachings may also be used with connection-oriented protocols such as HTTPS, TLS and SSFI which are based on the Transport Control Protocol (TCP) where the delivery of all packets is guaranteed and acknowledged. In those protocols, a sliding window of OTPs is saved so that any unacknowledged packets can be re-transmitted as required by protocol. The sliding window may be adjusted when all the packets encrypted by the start of the OTP have been acknowledged. In applications where the number of packets is small, all OTPs may be saved.

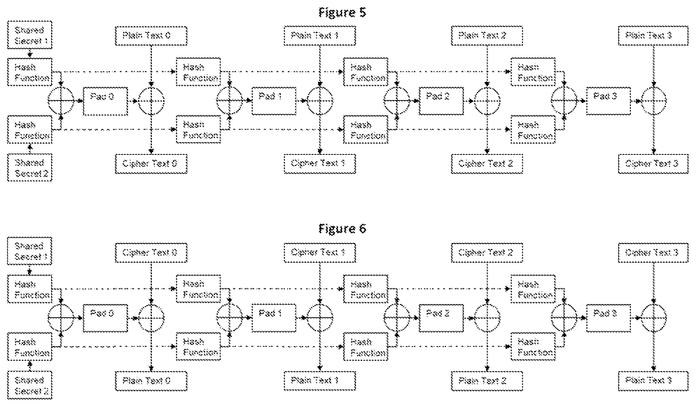

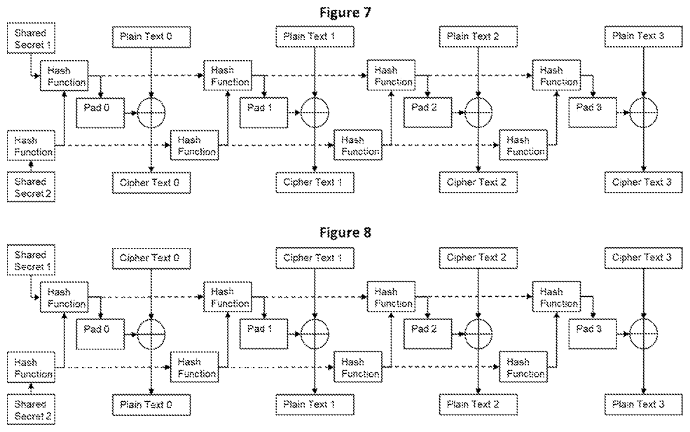

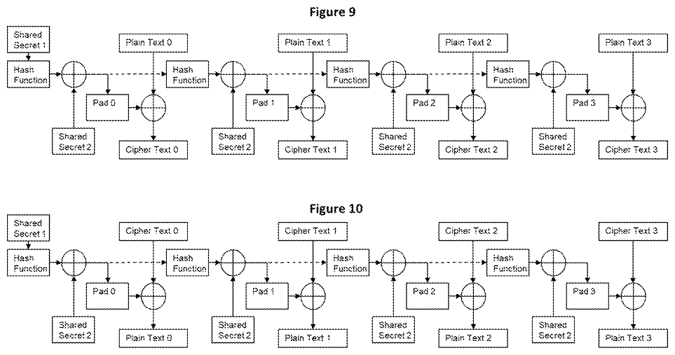

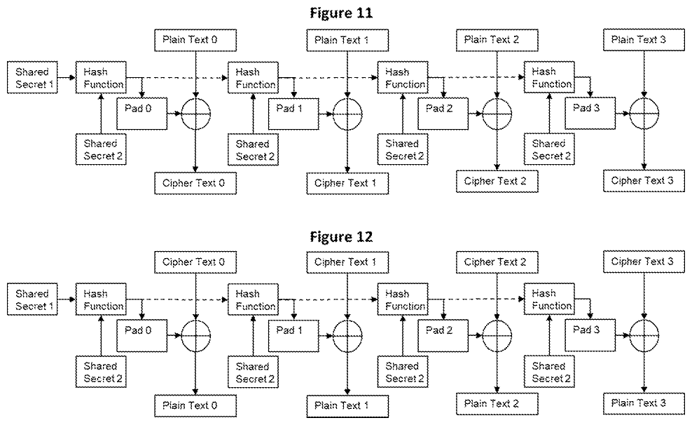

FIGS. 5 and 6 show the process of encrypting and decrypting using the hash function and to generate the pad as explained above. FIGS. 7-12 show variations to the process which enable secure encryption and decryption using a secret and a hash, FIGS. 7-8 depict a variation with two secrets and a double hash. FIGS. 9-10 depict a variation with a single hash combined with a XOR function. FIGS. 11-12 show yet another variation with a one hash function.

For adherence to current security standards, a hash function of SHA256 or better may be used. Currently, if a SHA256 algorithm is used, then the digest size of 256 bits will produce an OTP value of 256 bits for each step of the present teachings and provides a secure and efficient protocol.

For a hash algorithm, the block size may be determined by the digest size of the hash algorithm. For example, for the hash algorithm SHA2-512, the size of each data block will be 512 bits, Accordingly, the size of the OTP may be selected to be 512 bits. Moreover, all of the variables, including 501c, 501s, 502c, 502s, 800c, 800s, 800c-1, 800s-1, 900c, 900s, 900c-1, 900s-1, 1000s, 1000c-1, etc., may all be 512 bits, for efficiency. Alternatively, other types of hash algorithms, including SHA2-384, SHA2-512, SHA3-256, SHA3-384 and SHA3-512 may be used. Less secure algorithms, such as SHA-1 may be used but will result in smaller block sizes and may be less secure. In the future, if more secure hash algorithms come into use, they may also be practiced with this invention. Use of hash algorithms make the protocol quantum resistant.

In an alternative embodiment, each step of storage or transmission may be combined with or modified by other security methods to achieve the desired level of security. For example, to enhance data integrity a digital signature may be applied or pre-applied to the entire Plaintext 700. Alternatively, multiple digital signatures could be calculated or pre-calculated for every plain text block or every multiple plain text blocks, to provide a method to verify the integrity of the received plaintext. This may also be achieved with a hash-based message authentication protocol (HMAC).

While the invention is not limited to a particular security scheme, it is beneficial as a one-time pad for a Vernam cipher. To date, no good processes exist to securely and efficiently create an OTP for a Vernam cipher to transmit large quantities of data. The present teachings allow the OTP to be generated in a fast and secure manner by using the two shared secrets and to be generated recursively to provide an infinite length key for the Vernam cipher.

The present teachings can be applied to simultaneous transmission of data from server to client. Data can be encrypted according to the present teachings and simultaneously transmitted to the server while the server is transmitting to the client. This simultaneous transmission can be achieved by duplicating the services from the server to the client in the reverse direction and using 2i shared secrets—i for each direction of transmission.

This process is described with respect to transmission of data from the server to the client. But as would be understood in the art, this process may also be applied to transmission from a client to a server, between peer-to-peer parties, or for storing and retrieving information by a single party, without limitation. Moreover, the steps on the server side and the client side may be performed simultaneously, sequentially, or in a combination of the two.

The present teachings may be used to securely encrypt data at rest as mentioned above. The data at rest could be protected with a password. The password could then be used with a Password Based Key Derivation Function (PBKDF or PBKDF2) to generate the two shared secrets. To decrypt the data, the user would enter the password, which would be used to generate the two shared secrets. The shared secrets could then be used to generate the OTP key stream to decrypt the data. Confidentiality can be modified or combined with other methods such as a single digital signature to provide integrity.

The present teachings may also be used to generate keys for AES protocols. For example, each nth OTP block can be used as an AES encryption key. For example, the client and the server will agree on an initial AES key number either randomly or by another agreed method if the key number is “k,” then the client and the server iterate through the OTP generation process (e.g., Steps 1 through 4 as shown in FIG. 1), k times.

For example, a client and server could initially agree to use a key number k=107 as part of the session initiation process. The client and server would then separately iterate as taught above 107 times to generate OTP 107. This key may be used as AES key 107 to encrypt the data.

The selected AES key can be used for an entire session or it can be changed at any time by either the client or the server. The change may be directed to change to another key by information embedded in the data or may be directed by an out of band mechanism. For example, one of the parties, for example the server, may decide to change the AES key after a particular time or at particular time intervals. The server may send a command to change the AES key to, for example, k=33. The client and the server would then iterate through the RHIP process 33 times to generate and select the new key 33. The keys may change as often as necessary to achieve the appropriate level of security.

The present teachings can be implemented in hardware, in software, or in firmware. A software implementation may have one or more separate client and server threads running on the respective computing devices. A hardware implementation would operate similarly but would be implemented as part of a large ASIC, programmable logic device, or a dedicated or shared processor. The present teachings may also be implemented in a combination of hardware and software, as well as incorporated into firmware.

In various embodiments, the process of the present teachings may include additional application specific hardware or software (“modules”), engines, or components, or other suitable implementations that provide the described functionality. Each individual function or module may include separately configured computing devices or be combined into one. Moreover, some of the described functions may include instructions that are stored or on storage media. Programming code for carrying out operations for aspects of the present teachings may be constructed in any known format including as an application and may be written in any combination of one or more programming languages.

The code may execute separately on each party's computing device or may be accessed at a common location remotely or locally. As such, the code or executable instructions may reside in any location local or remote. Such may be the case for the data associated with each step of the process or each of the parties, for example the client or the server. For example, if a value is saved at the client, on the client, or client side, that value is stored for use by and accessible by the client, But in reality, the physical location of this storage may be remote from the physical location of other parts of the client's device or remote from the code executing the process to save or store that data.

Many modifications and variations will be apparent, to the person of ordinary skill in the art in view of the present teachings without departing from the scope and spirit of these teachings. Such modifications or variations are contemplated by the applicant and the teachings herein are intended as explanations to illuminate the present teachings and not as limiting examples. The breadth and scope of the claims are not to be limited by the particulars set forth in the specific embodiments described.

1. A method of securely moving data from a first device to a second device comprising the steps of
a. establishing a communication session between the first device and the second device;
b. storing a first secret on the first device;
c. storing the first secret on the second device;
d. storing a second secret on the first device;
e. storing the second secret on the second device;
f. combining a first information derived from the first secret with second information derived from the second secret, using one of an exclusive or function or a hash function, on the first device to create a first iteration-one key;
g. combining a third information derived from the first secret with fourth information derived from the second secret, using one of an exclusive or function or a hash function, on the second device to create a second iteration-one key;
h. encrypting at least a portion of the data on the first device using the first iteration-one key to generate a first encrypted text;
i. moving the first encrypted text from the first device to the second device; and
j. decrypting the first encrypted text using the second iteration-one key on the second device.

2. A method according to claim 1 further comprising:
a. replacing the first secret with the first information on the first device; and
b. replacing the second secret with the second information on the first device.

3. A method according to claim 2 further comprising:
a. replacing the first secret with the third information on the second device; and
b. replacing the second secret with the fourth information on the second device.

4. A method according to Claim 1 further comprising
a. replacing the first secret with the third formation on the second device; and
b. replacing the second secret with the fourth information on the second device.

5. A method according to Claim 1 further comprising
a. a step of modifying the first secret by adding the first information to the first secret to generate a modified first secret; and
b. using the modified first secret to generate a first iteration-two key to encrypt at least a portion of the data on the first device.

6. A method according to claim 5 further comprising the step of transmitting the encrypted at least a portion of the data to the second device.

7. A method according to claim 1 further comprising the steps of modifying the first iteration-one key n successive times to create a first iteration-n key.

8. A method according to claim 1 further comprising multiple steps of modifying the first secret by replacing it with a hash value derived in an iteration to generate a new key for encrypting at least a portion of the data.

9. A method according to Claim 1 wherein the first secret and the second secret are derived from an initial secret.

10. A method according to claim 9 where the initial secret is generated during a handshake between the first device and the second device.

11. A method according to claim 1 wherein the first information and the second information are derived by using one of a hash function or an exclusive or function.

12. A method according to claim 1 wherein the third information and the fourth information are derived by using one of a hash function or an exclusive or function.

13. A method according to claim 1 where a third secret is stored on the first device and on the second device, and wherein the third secret is used in generation of the first iteration-one key and the second iteration-one key.

14. A method for protecting the confidentiality of data comprising the steps of
a. selecting a key number;
b. storing a first secret;
c. storing a second secret;
d. combining a first information derived from the first secret with second information derived from the second secret using one of an exclusive or function or a hash function to create a first iteration key;
e. combining the first iteration key with the first secret to create a second iteration key;
f. continuing to combine each iteration key with the previous iteration key a number of iterations equal to the key number to obtain the final iteration key;
g. encrypting at least a portion of the data using the final iteration key to generate a first encrypted text; and
h. decrypting the first encrypted text using the final iteration key.

15. A system which securely moves data from a first location to a second location comprising
a. an electronic pathway from the first location to the second location;
b. first memory associated with the first location wherein said first memory stores a first secret for use on the first location;
c. second memory associated with the first location wherein said second memory stores a second secret for use on the first location;
d. third memory associated with the second location wherein said third memory stores a first secret for use on the second location;
e. fourth memory associated with the second location wherein said fourth memory stores a second secret for use on the second location;
f. one of a first hash function or a first exclusive or function associated with the first location configured to generate a first key from processing one of the first secret or the second secret for the first location;
g. one of a second hash function or a second exclusive or function associated with the second location configured to generate a second key from processing one of the first secret or the second secret for the second location;
h. an encryption function associated with the first location configured to encrypt data for the first location with the first key;
i. a decryption function associated with the second device configured to decrypt the encrypted data from the first device using the second key; wherein the first and second keys are equal in value.

16. A system according to claim 15 wherein at least one of the first hash function, the second hash function, the first exclusive or function, the second exclusive or function is implemented in hardware in electrical communication with at least one of the first location or the second location.

17. A system according to claim 15 wherein at least one of the first hash function, the second hash function, the first exclusive or function, the second exclusive or function is implemented in software.

18. A system for encrypting data comprising
a. a processor configured to execute a hash function and an exclusive or function;
b. a mei Tory configured to store a first secret and a second secret;
c. a memory configured store a hash of the first secret as a first hash and a hash of the second secret as a second hash;
d. a processor configured to combine the first and second hashes using an exclusive or function to obtain a first-iteration key;
e. an encryption module configured to encrypt at least a first portion of the data using the first iteration key to obtain a first ciphertext;
f. communication module configured to transmit said first ciphertext;
g. a processor configured to replace the first secret with the first hash to obtain a third hash and to replace the second secret with the second hash to obtain a fourth hash;
h. a processor configured to combine the third and fourth hashes using an exclusive or function to obtain a second-iteration key;
i. the encryption module additionally configured to encrypt at least a second portion of the data using the second iteration key as the cipher to obtain a second ciphertext; and
j. the communication module additionally configured to transmit said second ciphertext.

19. The system according to claim 15 wherein the processor is configured to concatenate a subsequent hash from the first secret with a previous hash from the first secret and combine the result with the concatenation of a subsequent hash from the second secret with a previous hash from the second secret, a desired number of times.
